(19) United States
(12) Patent Application Publication
(10) Pub. No.: US 2026/0234060 A1
(43) Pub. Date: Aug. 13, 2026

(54) KITS COMPRISING INTUMESCENT COATING COMPOSITIONS AND PRIMERS

(71) Applicant: 3M INNOVATIVE PROPERTIES COMPANY, St. Paul, MN (US)

(72) Inventors: Peter T. Dietz, Eagan, MN (US); Dinh Ba Le, Deceased, MN (US)

(21) Appl. No.: 19/156,036

(22) PCT Filed: Feb. 16, 2024
(86) PCT No.: PCT/IB2024/051504

§ 371 Date: Aug. 13, 2025

Related U.S. Application Data
(60) Provisional application No. 63/485,781, filed on Feb. 17, 2023.

(51) Int. Cl. C04B 28/26; C04B 111/00; C09D 1/02; C09D 5/18; C09D 7/61; C09D 7/63

(52) U.S. Cl. CPC C04B 28/26; C09D 1/02; C09D 5/185; C09D 7/61; C09D 7/63; C04B 2111/00508

(57) ABSTRACT

The present disclosure relates to an intumescent coating and a coated article, wherein the intumescent coating comprises an inorganic binder and at least one inorganic filler. In certain preferred embodiments, the inorganic binder is selected from potassium silicate, sodium silicate, or a combination thereof, and the at least one inorganic filler is selected from clay (e.g., kaolin clay), ceramic fibers, vermiculite, hollow ceramic microspheres, perlite, zeolite, mica, hexagonal boron nitride, silicon nitride and combinations thereof. The coated article comprises a substrate having a first major surface and a second major surface, and an intumescent coating disposed on the first major surface. The present disclosure also relates to kits comprising an intumescent coating and at least one primer. In general, the primer is used to prepare the surface of a substrate on which the coatings are applied.

The present disclosure relates to an intumescent coating comprising an inorganic binder and an inorganic filler. The intumescent coating can be used in an electric vehicle battery enclosure to mitigate the risk of fire or explosions occurring within individual compartments inside the battery module. The present disclosure also relates to kits comprising an intumescent coating and at least one primer. In general, the primer is used to prepare the surface of a substrate on which the coatings are applied.

### BACKGROUND

Electrical vehicle batteries are made up of several battery modules, and each battery module comprises many interconnected individual battery cells. When one cell in a battery module is damaged or faulty in its operation, temperatures in the cell may increase faster than heat can be removed from the module. If this temperature buildup continues unchecked, a catastrophic phenomenon called thermal runaway can occur resulting in the cell catching on fire. The resulting fire can spread very quickly to neighboring cells and then to cells throughout the entire battery in a chain reaction. These fires can be potentially massive and can spread to surrounding structures and endanger occupants of the vehicle or damage other structures in which these batteries are located.

When a thermal runaway event occurs in a cell, it is desirable for a thermal management system to block or absorb the heat and prevent adjacent cells or modules from overheating and themselves entering thermal runaway. The severe risks posed by thermal runaway event requires battery modules to be designed with thermally insulating barriers to mitigate the effect of the thermal runaway event and provide time for occupants to safely vacate the vehicle in the event of a fire.

### SUMMARY

In one aspect of the disclosure, a protection intumescent coating is provided that comprises an inorganic binder and at least one inorganic filler. In another aspect, this disclosure is directed to a kit comprising a protection intumescent coating along with a suitable primer.

The intumescent coating composition comprises an inorganic binder and at least one inorganic filler, wherein the inorganic binder is selected from potassium silicate, sodium silicate, or a combination thereof, and wherein the at least one inorganic filler is preferably chosen from clay (e.g., kaolin clay), vermiculite, perlite, zeolite, mica, hexagonal boron nitride, silicon nitride and combinations thereof. The composition may also contain talc, mullite, ceramic fibers, hollow ceramic microspheres, phlogopite, muscovite montmorillonite, smectite, bentonite, illite, chlorite, sepiolite, attapulgite, halloysite, laponite, rectorite, perlite and combinations thereof.

In those embodiments, the composition has a shear thinning viscosity at a shear rate of 1·s⁻¹ of at least 275 Pa·s, a shear thinning viscosity at a shear rate of 100·s⁻¹ of less than 10 Pa·s; a moisture content of 35 weight percent (wt %) to 55 wt % with respect to the total weight of the composition; and the composition intumesces at a temperature above 100° C. In some preferred embodiments, the composition does not burn when exposed to a temperature of 1350° C.

In another aspect of the present disclosure, a coated article is provided comprising the intumescent coating composition described above.

The intumescent coating of this disclosure can be especially useful, for example, not only in automotive applications, but also in stationary energy storage, residential, industrial, and aerospace applications, where it is necessary to protect people or surrounding structures from the effects of a fire. For example, the provided fire protection articles can be incorporated into primary structures extending along or around transportation or building compartmental structures to protect users and occupants. Such applications can include fire protection around lithium battery modules, fuel tanks, cables, cable trays, metallic (i.e., steel) pipes and any other enclosures or compartments.

All scientific and technical terms used herein have meanings commonly used in the art unless otherwise specified. The definitions provided herein are to facilitate understanding of certain terms used frequently in this application and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

In the context of this disclosure, when the composition “does not burn” at a given temperature (e.g., 1,200° C. or 1,350° C.) we mean that no smoke or flame is observed when the composition is exposed to that temperature.

In the context of this disclosure, an “intumescent coating” refers to a coating that is capable of expanding in volume upon being heated to an intumescent temperature. Intumescence does not include expansion that can be measured only as a function of a coefficient of thermal expansion.

In the context of this disclosure, a “shear thinning viscosity” at a given shear rate (e.g., 1·s⁻¹ or 100·s⁻¹) means the value obtained when performing the test described in the Example section under the title “shear thinning viscosity” conducted at the given shear rate.

In the context of this disclosure, a composition that is “sprayable” means that the composition is capable of being applied to a substrate by known spraying equipment.

In the context of this disclosure, a composition that is “extrudable” (non-atomized flat stream) means that the composition is capable of being applied to a substrate by known extrusion equipment.

In the context of this disclosure, a “solution” refers to a liquid composition having a single phase. In contrast, a “emulsion” refers to a composition having a liquid phase and a solid phase (e.g., particles) dispersed in it.

### BRIEF DESCRIPTION OF THE DRAWINGS

FIG. 1 shows results from Torch & Grit testing for various exemplary intumescent coatings.

FIG. 2 shows the correlation between dry basis weight coverage (grams per square meter (gsm)) as a function of coating thickness.

FIG. 3 shows the temperature curve for heating a hot plate.

### DETAILED DESCRIPTION

In the following detailed description, reference is made to the accompanying drawings, which form a part hereof, and in which is shown by way of illustration specific embodiments in which the disclosure can be practiced.

Protecting against the dangers associated with a sudden fire during a thermal runaway event is a significant technical challenge. Attempting to create a universal solution is difficult to achieve because protecting against one characteristic of a battery fire could potentially cause other types of problems. For example, non-woven polymeric webs and foams can display excellent thermal insulation properties, but common polymers tend to be flammable or need to be coated with encapsulant materials that may be flammable. Heat shield materials made from woven non-combustible fibers (e.g., inorganic fibers) can be effective in preventing penetration of a fire but can be too thin to adequately insulate against the intense heat of a fire and may also be too fragile to withstand explosive flame and particulate matter. Using thicker layers of heat shield materials may too costly. Combinations of these materials could work, but bonding dissimilar materials together can be an issue, especially when the selection of bonding materials may be constrained by flammability concerns.

The present disclosure addresses those problems by providing an intumescent coating that forms a protective ceramic surface under thermal runaway conditions. Application of the intumescent coating to a substrate creates a coated article. Certain articles may have surfaces on which intumescent coatings have poor adhesion. For those articles, a primer may be needed on the surface on which the coating will be applied. The present disclosure also addresses that need by providing kits that contain an intumescent composition and a suitable primer.

### Intumescent Coating

The intumescent coating may be applied to substrates in a variety of locations within the enclosure of a battery module. For instance, the coating could be applied wherever blast protection and thermal insulation is desired. Specific examples include under enclosure lid, on the vertical sides of the enclosure, and/or bottom of the enclosure. The coating could also be applied on battery module covers within the primary enclosure, including along specifically design vent paths. Throughout this disclosure, a “liquid composition” or “coating composition” refers to the composition which, when dried on a substrate, creates an intumescent coating. That is, an intumescent coating refers to the dried state of the liquid composition. In some embodiments, the intumescent coating has a water content from 10 wt % to 25 wt % with respect to the weight of the dried composition (intumescent coating).

In one aspect of the disclosure, the intumescent coating comprises an inorganic binder and at least one inorganic filler.

The intumescent coating may be created by applying the liquid composition to a substrate by spraying, extruding, or the like.

In certain preferred embodiments, the liquid composition has a shear thinning viscosity at a shear rate of 1·s⁻¹ of at least 275 Pa·s and a shear thinning viscosity at a shear rate of 100·s⁻¹ of less than 10 Pa·s. The liquid composition has a moisture content of 35 wt % to 55 wt % with respect to the total weight of the composition.

When the liquid composition is dried to a moisture content from 10 wt % to 25 wt % with respect to the total weight of the composition to create a “dried composition,” the intumescent coating is created. The dried composition, when it has a moisture content of 15 wt %±3 wt %, intumesces at a temperature of 100° C. or higher. In general, the temperature at which intumescence begins depends on the water content of the composition. For instance, the lower the concentration of water the higher is the intumescence temperature. The intumescent coatings of this disclosure have preferably a minimum amount of 10 wt % of water, with respect to the total weight of the coating.

Exemplary inorganic binders include sodium silicate, potassium silicate or a combination thereof. In some embodiments, the inorganic binder can be a polysilicate having the formula M₂O(SiO₂)ₙ·H₂O, wherein M is selected from Li, Na, K, preferably Na or K and n is an integer between 1 and 15, preferably between 3 and 9. It is further preferred that the polysilicate is employed in a solvent, preferably water. In other embodiments, the inorganic binder can be Na₂SiO₃. The exemplary coating composition comprises 10 wt. %-80 wt. % inorganic binder based on the percent solids in the dried coating, preferably 20 wt. %-60 wt. % inorganic binder.

In certain preferred embodiments, the coating composition comprises less than 0.4 molar ratio of alkali metal to boron. In more preferred embodiments, the coating composition comprises less than 0.2 molar ration of alkali metal to boron. In other embodiments, the coating composition comprises less than 0.1 molar ration of alkali metal to boron. In some embodiments, the coating composition is essentially free of boron (less than 0.1 wt %) but can include boron fillers, such as hexagonal boron nitride.

The particulate inorganic filler content in the coating composition will be from about 20 wt. %-70 wt. % based on the total weight of the liquid composition, preferably 25 wt. %-40 wt. %, and more preferably 30 wt. %-37 wt. %. Exemplary inorganic fillers include, but are not limited to kaolin clay, talc, mica, mullite, phlogopite, muscovite montmorillonite, smectite, bentonite, illite, chlorite, sepiolite, attapulgite, halloysite, vermiculite, laponite, rectorite, perlite, and combinations thereof. Suitable types of kaolin clay include, but are not limited to, water-washed kaolin clay; metakaolin clay, delaminated kaolin clay; calcined kaolin clay; and surface-treated kaolin clay.

In certain preferred embodiments, the liquid composition comprises a humectant. In some embodiments, the humectant is a polyhydric alcohol. In other embodiments, the humectant is chosen from glycerin, sorbitol, sucrose, glucose, other sugars, polyethylene glycol, and combinations thereof. In certain preferred embodiments, the humectant is present from 0.1 wt % to 2 wt %, based on the total weight of the composition.

In some embodiments, a polymeric binder material can be added to the exemplary coating composition. Exemplary polymeric binders include (meth)acrylic binders, rubber-based binders, styrene acrylic binders, styrene butadiene binders, urethane acrylate binders, silicone binders, vinyl polymer binders, epoxy binders and the like. In exemplary embodiments, the polymeric binders can be waterborne polymer dispersions based on acrylate-, styrene, urethane monomers and the like, or compositions/copolymers thereof.

In some embodiments, additives can be added to the exemplary coating composition. Exemplary additives include defoamers, surfactants, rheological modifiers, forming aids, pH-adjusting materials, etc. Exemplary rheological modifiers can be an organic compound, preferably wherein the organic compound is selected from polysaccharides, proteins and polyvinyl alcohols, preferably are selected from natural and modified polysaccharides, preferably polysaccharides selected from the list consisting of xanthan, carrageenan, pectin, gellan, xanthan gum, diuthan, cellulose ethers such as carboxymethyl cellulose, methyl cellulose, ethyl cellulose and hydroxyethyl cellulose.

As mentioned previously, the intumescent coating composition may be applied to the first major surface of a substrate to form a coated article, which can serve a protective function and act as a thermal/flame barrier. For instance, the intumescent composition may be applied under the lid or other areas of a battery enclosure.

In some embodiments, the liquid compositions of this disclosure have a shelf life of at least 3 months. A successful shelf life of a given time period means that no precipitates or gels are observed, and in any event gels or precipitates are present at less than 1 wt % of the total weight of the liquid composition. Additionally, a suitable shelf life means the difference between solids in the top and bottom portions of the container is less than 2 wt % as measured in the Shelf Life test described in the Example section.

In certain embodiments, the intumescent composition, or the dried composition do not comprise a scrim, an insulation layer, a layer having low thermal conductivity, a layer that is non intumescent, expandable graphite, ceramic fibers, a fibrous insulation layer, or inorganic fibers. In some embodiments, the dried composition is a single layer.

### Primer

The kits of the present disclosure comprise a primer. The primer can be applied on the surface on which the intumescent composition will be applied. In some embodiments, the primer is chosen from amino silane, metal alkoxide and acrylate, and commercial primers 3M Adhesion Promoter 111 and 3M Adhesion Promoter 4298UV.

### Kits

Kits of the present disclosure comprise an intumescent coating composition and at least one primer. Kits may comprise any of the liquid compositions described in this application in combination with one or more of the primers described in the application.

In certain embodiments, the kits comprise both components (liquid compositions and primers) in the same container. This does not mean that the liquid intumescent composition is mixed with the primer to produce a single composition, but rather that a container A holds the liquid intumescent composition and a separate container B holds the primer and both containers A and B are inside the same package or similar overall holding container.

In other embodiments, the two kit components may be sold or purchased separately, or received separately by the user, but they would still be considered part of a kit of this disclosure. Indeed, the two components need not be stored together (in the same container) or in the vicinity of each other in order for them to be considered part of a kit.

### Coated Article

In another aspect of the present disclosure, an article is provided that comprises an intumescent coating disposed on a given area of a substrate. The area on the substrate could be any portion of any item inside a battery enclosure, including the casing or enclosure itself. The coating compositions described in the preceding section can be applied to a substrate to create articles exhibiting high impact and high thermal transfer resistance in high temperature applications. Additionally, the substrates are typically flame resistant.

The coating composition can be applied by spraying, extruding, or the like in thicknesses of 0.4 millimeters (mm) to 5 mm, preferably 2 mm to 3 mm on a wet basis. On a dry basis the coatings can have a thickness of 0.2 millimeters (mm) to 3 mm, preferably 1 mm to 2 mm.

In some preferred embodiments, the liquid composition is dried to a moisture content from 10 wt % to 25 wt % with respect to the total weight of the composition to create a “dried composition,” also known as an intumescent composition. The intumescent composition, when it has a moisture content of 15 wt %±3 wt %, intumesces at a temperature of 100° C. or higher. It is possible, however, to have intumescent compositions having a water content lower than 10 wt %, in which case the composition will intumesce at a higher temperature and will have a lower percent expansion. The dried coating creates a ceramic coating that protects the article against conditions prevalent under thermal runaway incidents, or at least decreases the adverse effects of such conditions.

In some embodiments, the article is made of a coated metal on which the intumescent coating is applied. In some of those embodiments, a primer as described above is applied to the coated metal surface before the coating composition is applied.

In other embodiments, the coated article further comprises an overcoat layer comprising rubber, silicone, oxidized linseed oil, acrylic, polyurethane, polymethacrylate, latex, other water-insoluble polymers, and combinations thereof.

Typically, the coverage of the intumescent composition on the substrate is in the range from 500 gsm to 5000 gsm, preferably from 2000 gsm to 4000 gsm. In some instances, the intumescent layer has a thickness greater than 0.5 mm.

Depending on their viscosity, the compositions of the invention may be applied in the same way as a water-based emulsion paint, e.g., by brushing, roller coating, dipping and spraying to a variety of surfaces, or extruded through the nozzle of a caulk gun. The fire protection effectiveness of the coating increases with film thickness.

In certain embodiments, the coated article does not comprise a scrim, an insulation layer, a layer having low thermal conductivity, a layer that is non intumescent, expandable graphite, ceramic fibers, a fibrous insulation layer, or inorganic fibers.

In some preferred embodiments, the dried coating provides blast resistance to the coated article. For instance, in some embodiments, the coated article of the present disclosure can survive (no penetration) at least 1, at least 3, at least 4, at least 5, at least 9, or at least 12 blasts of abrasive media at 1,350° C., 1200 C in this case as determined by the Torch and Grit Test in the Example Section.

In other embodiments, the disclosure is also directed to a method of applying an intumescent coating to a substrate comprising:
applying a primer to a substrate, wherein the primer is in a solution or emulsion,
drying the primer solution or emulsion to create a primer surface;
applying a liquid composition to the primer surface,
wherein the primer is an acrylic polymer,
wherein the liquid composition comprises:
   an inorganic binder chosen from potassium silicate, sodium silicate, or a combination thereof, and
   at least one inorganic filler;
wherein the composition has a shear thinning viscosity at a shear rate of 1·s−1 of at least 275 Pa·s;
wherein the composition has a shear thinning viscosity at a shear rate of 100·s−1 of less than 10 Pa·s;
wherein the composition has a moisture content of 35 wt % to 55 wt % with respect to the total weight of the composition;
wherein the liquid composition is capable of being dried to a moisture content from 10 wt % to 25 wt % with respect to the total weight of the composition,
wherein the dried composition, when it has a moisture content of 15 wt %±5 wt %, intumesces at a temperature of 100° C. or higher.

The drying of the primer solution/emulsion could be either active (e.g., in an oven or with other drying equipment) or passive (e.g., just allowing the solution/emulsion to dry at room temperature.)

### EXEMPLARY EMBODIMENTS

### Composition Embodiments

1. A liquid composition comprising:
   an inorganic binder chosen from potassium silicate, sodium silicate, or a combination thereof, and
   at least one inorganic filler;
   wherein the composition has a shear thinning viscosity at a shear rate of 1·s⁻¹ of at least 275 Pa·s;
   wherein the composition has a shear thinning viscosity at a shear rate of 100·s⁻¹ of less than 10 Pa·s;
   wherein the composition has a moisture content of 35 wt % to 55 wt % with respect to the total weight of the composition;
   wherein the liquid composition is capable of being dried to a moisture content from 10 wt % to 25 wt % with respect to the total weight of the composition,
   wherein the dried composition, when it has a moisture content of 15 wt %±5 wt %, intumesces at a temperature of 100° C. or higher;
2. A liquid composition according to any of the preceding embodiments, wherein the composition has a shear thinning viscosity at a shear rate of 1·s−1 of 275 Pa·s to 1000 Pa·s.
3. A liquid composition according to any of the preceding embodiments, wherein the composition has a shear thinning viscosity at a shear rate of 1·s⁻¹ of 300 Pa·s to 1000 Pa·s.
4. A liquid composition according to any of the preceding embodiments, wherein the composition has a shear thinning viscosity at a shear rate of 100·s⁻¹ of less than 9 Pa·s.
5. A liquid composition according to any of the preceding embodiments, wherein the composition has a shear thinning viscosity at a shear rate of 100·s−1 of from 0.5 Pa·s to 10 Pa·s.
6. A liquid composition according to any of the preceding embodiments, wherein the composition has a shear thinning viscosity at a shear rate of 100·s−1 of from 0.5 Pa·s to 9 Pa·s.
7. A liquid composition according to any of the preceding embodiments, wherein the composition has a shear thinning viscosity at a shear rate of 100·s−1 of from 1 Pa·s to 10 Pa·s.
8. A liquid composition according to any of the preceding embodiments, wherein the composition has a shear thinning viscosity at a shear rate of 100·s−1 of from 1 Pa·s to 9 Pa·s.
9. A liquid composition according to any of the preceding embodiments, wherein the composition is sprayable and/or extrudable.
10. A liquid composition according to any of the preceding embodiments, wherein the composition has a moisture content of 35 wt % to 50 wt % with respect to the total weight of the composition.
11. A liquid composition according to any of the preceding embodiments, wherein the composition has a moisture content of 35 wt % to 45 wt % with respect to the total weight of the composition.
12. A liquid composition according to any of the preceding embodiments, wherein the composition has a moisture content of 40 wt % to 45 wt % with respect to the total weight of the composition.
13. A liquid composition according to any of the preceding embodiments, wherein the composition has a moisture content of 42±1.5 wt % with respect to the total weight of the composition.
14. A liquid composition according to any of the preceding embodiments, wherein the inorganic filler is chosen from: clay, ceramic fibers, vermiculite, hollow ceramic microspheres, perlite, zeolite, mica, hexagonal boron nitride, silicon nitride, and combinations thereof.
15. A liquid composition according to any of the preceding embodiments, wherein the inorganic filler is a kaolin clay.
16. A liquid composition according to any of the preceding embodiments, wherein the inorganic filler is present in an amount from 20 wt % to 70 wt %.
17. A liquid composition according to any of the preceding embodiments, wherein the inorganic filler is a clay and is present in an amount from 26.5 wt % to 40 wt %.
18. A liquid composition according to any of the preceding embodiments, wherein the inorganic filler is a clay and is present in an amount from 27 wt % to 39 wt %.
19. A liquid composition according to any of the preceding embodiments, wherein the inorganic filler is a clay and is present in an amount from 27.5 wt % to 38.5 wt %.
20. A liquid composition according to any of the preceding embodiments, wherein the inorganic filler is a clay and is present in an amount from 28 wt % to 38 wt %.
21. A liquid composition according to any of the preceding embodiments, wherein the inorganic filler is a clay and is present in an amount from 29 wt % to 37.5 wt %.
22. A liquid composition according to any of the preceding embodiments, wherein the inorganic filler is a clay and is present in an amount from 30 wt % to 37 wt %.
23. A liquid composition according to any of the preceding embodiments, wherein the composition has a shelf life of 3 months or greater.
24. A liquid composition according to any of the preceding embodiments, wherein the composition has a shelf life of 6 months or greater.
25. A liquid composition according to any of the preceding embodiments, wherein the composition has a shelf life of 9 months or greater.
26. A liquid composition according to any of the preceding embodiments, wherein the composition has a shelf life of 12 months or greater.
27. A liquid composition according to any of the preceding embodiments, wherein the composition has a shelf life from 6 months to 12 months.
28. A liquid composition according to any of the preceding embodiments, wherein the composition has a shelf life from 6 months to 9 months.
29. A liquid composition according to any of the preceding embodiments, further comprising an additive chosen from fumed alumina and fumed titania.
30. A liquid composition according to any of the preceding embodiments, wherein the composition has a decreasing ramp yield stress equal or greater than 245 Pa.
31. A liquid composition according to any the preceding embodiments further comprising a humectant.
32. A liquid composition according to any the preceding embodiments further comprising a humectant, wherein the humectant is a polyhydric alcohol.
33. A liquid composition according to any the preceding embodiments further comprising a humectant, wherein the humectant is chosen from glycerin, sorbitol, sucrose, glucose, other sugars, polyethylene glycol, and combinations thereof.
34. A liquid composition according to any the preceding embodiments further comprising a humectant in 0.1 wt % to 2 wt %, based on the total weight of the composition.
35. A coated article comprising the dried composition according to any of the embodiments directed to a liquid composition, wherein the coated article optionally comprises a primer coated on the article in between the article and the dried composition.
36. A coated article comprising the dried composition according to any of the embodiments directed to a liquid composition, wherein the dried composition has a moisture content from 10 wt % to 25 wt %.
37. A coated article comprising the dried composition according to any of the embodiments directed to a liquid composition, wherein the dried composition does not burn when exposed to a temperature of 1350° C.
38. A coated article comprising the dried composition according to any of the embodiments directed to a liquid composition in contact with a surface of the article, wherein the coated article comprises a primer on the surface that is in contact with the dried composition.
39. A coated article comprising the dried composition according to any of the embodiments directed to a liquid composition in contact with a surface of the article, wherein the article is made of a coated metal and comprises a primer on the surface that is in contact with the dried composition.
40. A coated article comprising the dried composition according to any of the embodiments directed to a liquid composition in contact with a surface of the article, wherein the article is made of a coated metal, comprises a primer on the surface that is in contact with the dried composition, and wherein the primer is chosen from amino silane, metal alkoxide and acrylate, and commercial primers 3M Adhesion Promoter 111 and 3M Adhesion Promoter 4298UV.
41. A coated article comprising the dried composition according to any of the embodiments directed to a liquid composition further comprising an overcoat layer comprising rubber, silicone, oxidized linseed oil, acrylic, polyurethane, polymethacrylate, latex, other water-insoluble polymers, and combinations thereof.
42. A coated article comprising the dried composition according to any of the embodiments directed to a liquid composition wherein the composition on the coated article has a coverage of 500 gsm to 5000 gsm.
43. A coated article comprising the dried composition according to any of the embodiments directed to a liquid composition wherein the composition on the coated article has a coverage of 2000 gsm to 4000 gsm.
44. A coated article comprising a layer made of the dried composition according to any of the embodiments directed to a liquid composition on at least a portion of a surface of the article, wherein the layer has a thickness greater than 0.5 mm.
45. A coated article comprising a layer made of the dried composition according to any of the embodiments directed to a liquid composition, wherein the coating composition is sag resistant to a thickness of up to 3 mm under the Sag Resistant Test.
46. A coated article comprising a layer made of the dried composition according to any of the embodiments directed to a liquid composition, wherein the coating composition is sag resistant to a thickness of up to 2.5 mm under the Sag Resistant Test.
47. A coated article comprising a layer made of the dried composition according to any of the embodiments directed to a liquid composition, wherein the coating composition is sag resistant to a thickness of up to 2 mm under the Sag Resistant Test.
48. A coated article comprising a layer made of the dried composition according to any of the embodiments directed to a liquid composition, wherein the coating composition is sag resistant to a thickness in the range from 0.4 mm to 3 mm under the Sag Resistant Test.
49. A coated article comprising a layer made of the dried composition according to any of the embodiments directed to a liquid composition, wherein the coating composition is sag resistant to a thickness in the range from 1 mm to 2 mm under the Sag Resistant Test.
50. A coated article comprising a layer made of the dried composition according to any of the embodiments directed to a liquid composition, wherein the intumesced (expanded) layer comprising the dried coating has a thickness at least 80% higher than the non-intumesced thickness when the remaining water in the intumesced layer is 10%.
51. A coated article comprising a layer made of the dried composition according to any of the embodiments directed to a liquid composition, wherein the intumesced layer comprising the dried coating has a thickness at least 100% higher than the non-intumesced thickness when the remaining water in the intumesced layer is 10%.
52. A coated article comprising a layer made of the dried composition according to any of the embodiments directed to a liquid composition, wherein the intumesced layer comprising the dried coating has a thickness at least 150% higher than the non-intumesced thickness when the remaining water in the intumesced layer is 10%.
53. A coated article comprising a layer made of the dried composition according to any of the embodiments directed to a liquid composition, wherein the intumesced layer comprising the dried coating has a thickness at least 180% higher than the non-intumesced thickness when the remaining water in the intumesced layer is 10%.
54. A coated article comprising a layer made of the dried composition according to any of the embodiments directed to a liquid composition, wherein the intumesced layer comprising the dried coating has a dielectric strength at least 2000% higher than the non-intumesced dielectric strength when measured according to the section “Measurement of Dielectric Strength”.

### Kit Embodiments

1. A kit comprising at least two components:
   a component A comprising a liquid composition comprising:
      an inorganic binder chosen from potassium silicate, sodium silicate, or a combination thereof, and
      at least one inorganic filler;
      wherein the composition has a shear thinning viscosity at a shear rate of 1·s⁻¹ of at least 275 Pa·s;
      wherein the composition has a shear thinning viscosity at a shear rate of 100·s⁻¹ of less than 10 Pa·s;
      wherein the composition has a moisture content of 35 wt % to 55 wt % with respect to the total weight of the composition;
      wherein the liquid composition is capable of being dried to a moisture content from 10 wt % to 25 wt % with respect to the total weight of the composition,
      wherein the dried composition, when it has a moisture content of 15 wt %±5 wt %, intumesces at a temperature of 100° C. or higher; and
   a component B comprising an acrylic polymer.
2. A kit according to any of the preceding embodiments, wherein component B is either a solution or an emulsion.
3. A kit according to any of the preceding embodiments, wherein component B is an aqueous emulsion comprising the acrylic polymer.
4. A kit according to any of the preceding embodiments, wherein component B comprises an acrylate copolymer.
5. A kit according to any of the preceding embodiments, wherein component B is an aqueous emulsion comprising an acrylate copolymer.
6. A kit according to any of the preceding embodiments, wherein component B is an aqueous emulsion comprising an acrylate styrene copolymer.
7. A kit according to any of the preceding embodiments, wherein component B is a non-aqueous solution comprising an acrylic polymer.
8. A kit according to any of the preceding embodiments, wherein component B is a non-aqueous solution comprising an acrylic copolymer.
9. A kit according to any of the preceding embodiments, wherein component B is a non-aqueous solution comprising an acrylic styrene copolymer.
10. A kit according to any of the preceding embodiments, wherein the liquid composition of component A has a shear thinning viscosity at a shear rate of 1·s−1 of 275 Pa·s to 1000 Pa·s.
11. A kit according to any of the preceding embodiments, wherein the liquid composition of component A has a shear thinning viscosity at a shear rate of 1·s−1 of 300 Pa·s to 1000 Pa·s.
12. A kit according to any of the preceding embodiments, wherein the liquid composition of component A has a shear thinning viscosity at a shear rate of 100·s−1 of less than 9 Pa·s.
13. A kit according to any of the preceding embodiments, wherein the liquid composition of component A has a shear thinning viscosity at a shear rate of 100·s−1 of from 0.5 Pa·s to 10 Pa·s.
14. A kit according to any of the preceding embodiments, wherein the liquid composition of component A has a shear thinning viscosity at a shear rate of 100·s−1 of from 0.5 Pa·s to 9 Pa·s.
15. A kit according to any of the preceding embodiments, wherein the liquid composition of component A has a shear thinning viscosity at a shear rate of 100·s−1 of from 1 Pa·s to 10 Pa·s.
16. A kit according to any of the preceding embodiments, wherein the liquid composition of component A has a shear thinning viscosity at a shear rate of 100·s−1 of from 1 Pa·s to 9 Pa·s.
17. A kit according to any of the preceding embodiments, wherein the liquid composition of component A is sprayable and/or extrudable.
18. A kit according to any of the preceding embodiments, wherein the liquid composition of component A has a moisture content of 35 wt % to 50 wt % with respect to the total weight of the liquid composition of component A.
19. A kit according to any of the preceding embodiments, wherein the liquid composition of component A has a moisture content of 35 wt % to 45 wt % with respect to the total weight of the liquid composition of component A.
20. A kit according to any of the preceding embodiments, wherein the liquid composition of component A has a moisture content of 40 wt % to 45 wt % with respect to the total weight of the liquid composition of component A.
21. A kit according to any of the preceding embodiments, wherein the liquid composition of component A has a moisture content of 42±1.5 wt % with respect to the total weight of the liquid composition of component A.
22. A kit according to any of the preceding embodiments, wherein the inorganic filler is chosen from: clay, ceramic fibers, vermiculite, hollow ceramic microspheres, perlite, zeolite, mica, hexagonal boron nitride, silicon nitride, and combinations thereof.
23. A kit according to any of the preceding embodiments, wherein the inorganic filler is a kaolin clay.
24. A kit according to any of the preceding embodiments, wherein the inorganic filler is present in an amount from 20 wt % to 70 wt %.
25. A kit according to any of the preceding embodiments, wherein the inorganic filler is a clay and is present in an amount from 26.5 wt % to 40 wt %.
26. A kit according to any of the preceding embodiments, wherein the inorganic filler is a clay and is present in an amount from 27 wt % to 39 wt %.
27. A kit according to any of the preceding embodiments, wherein the inorganic filler is a clay and is present in an amount from 27.5 wt % to 38.5 wt %.
28. A kit according to any of the preceding embodiments, wherein the inorganic filler is a clay and is present in an amount from 28 wt % to 38 wt %.
29. A kit according to any of the preceding embodiments, wherein the inorganic filler is a clay and is present in an amount from 29 wt % to 37.5 wt %.
30. A kit according to any of the preceding embodiments, wherein the inorganic filler is a clay and is present in an amount from 30 wt % to 37 wt %.
31. A kit according to any of the preceding embodiments, wherein the liquid composition of component A has a shelf life of 3 months or greater.
32. A kit according to any of the preceding embodiments, wherein the liquid composition of component A has a shelf life of 6 months or greater.
33. A kit according to any of the preceding embodiments, wherein the liquid composition of component A has a shelf life of 9 months or greater.
34. A kit according to any of the preceding embodiments, wherein the liquid composition of component A has a shelf life of 12 months or greater.
35. A kit according to any of the preceding embodiments, wherein the liquid composition has a shelf life from 6 months to 12 months.
36. A kit according to any of the preceding embodiments, wherein the liquid composition has a shelf life from 6 months to 9 months.
37. A kit according to any of the preceding embodiments, further comprising an additive chosen from fumed alumina and fumed titania.
38. A kit according to any of the preceding embodiments, wherein the liquid composition of component A has a decreasing ramp yield stress equal or greater than 245 Pa.
39. A kit according to any the preceding embodiments further comprising a humectant.
40. A kit according to any the preceding embodiments further comprising a humectant, wherein the humectant is a polyhydric alcohol.
41. A kit according to any the preceding embodiments further comprising a humectant, wherein the humectant is chosen from glycerin, sorbitol, sucrose, glucose, other sugars, polyethylene glycol, and combinations thereof.
42. A kit according to any the preceding embodiments further comprising a humectant in 0.1 wt % to 2 wt %, based on the total weight of the liquid composition of component A.
43. A coated article comprising an article, a primer coated on the article, and a layer coated on the coated primer, wherein the layer coated on the primer comprises the dried component A according to any of the preceding embodiments directed to a kit.
44. A coated article according to any of the preceding embodiments directed to coated articles comprising an article, a primer coated on the article, and a layer coated on the coated primer, wherein the layer coated on the primer comprises the dried component A according to any of the preceding embodiments directed to a kit, wherein the dried component A has a moisture content from 10 wt % to 25 wt %.
45. A coated article according to any of the preceding embodiments directed to coated articles comprising an article, a primer coated on the article, and a layer coated on the coated primer, wherein the layer coated on the primer comprises the dried component A according to any of the preceding embodiments directed to a kit, wherein the dried component A has a moisture content from 10 wt % to 25 wt %, wherein the article comprises a substrate and, wherein the substrate is e-coated steel.
46. A coated article according to any of the preceding embodiments directed to a coated article comprising the dried composition from component A according to any of the embodiments directed to a kit, wherein the dried composition does not burn when exposed to a temperature of 1350° C.
47. A coated article according to any of the preceding embodiments directed to a coated article comprising the dried composition from component A according to any of the embodiments directed to a kit, wherein the coated article comprises a primer on the surface that is in contact with the dried composition.
48. A coated article according to any of the preceding embodiments directed to a coated article comprising the dried composition from component A according to any of the embodiments directed to a kit, wherein the article is made of a coated metal and comprises a primer on the surface that is in contact with the dried composition.
49. A coated article according to any of the preceding embodiments directed to a coated article comprising the dried composition from component A according to any of the embodiments directed to a kit, wherein the article is made of a coated metal and comprises a primer on the surface that is in contact with the dried composition; wherein the coated metal is chosen from e-coat aluminum and e-coat steel.
50. A coated article according to any of the preceding embodiments directed to a coated article comprising the dried composition from component A according to any of the embodiments directed to a kit, wherein the article is made of a coated metal, wherein the primer coated on the article is in contact with the dried component A composition, and wherein the primer is chosen from amino silane, metal alkoxide and acrylate, and commercial primers 3M Adhesion Promoter 111 and 3M Adhesion Promoter 4298UV.
51. A coated article according to any of the preceding embodiments directed to a coated article comprising the dried composition from component A according to any of the embodiments directed to a kit, further comprising an overcoat layer comprising rubber, silicone, oxidized linseed oil, acrylic, polyurethane, polymethacrylate, latex, other water-insoluble polymers, and combinations thereof.
52. A coated article according to any of the preceding embodiments directed to a coated article comprising the dried composition from component A according to any of the embodiments directed to a kit, wherein the composition on the coated article has a coverage of 500 gsm to 5000 gsm.
53. A coated article according to any of the preceding embodiments directed to a coated article comprising the dried composition from component A according to any of the embodiments directed to a kit, wherein the composition on the coated article has a coverage of 2000 gsm to 4000 gsm.
54. A coated article according to any of the preceding embodiments directed to a coated article comprising the dried composition from component A according to any of the embodiments directed to a kit, wherein the layer has a thickness greater than 0.5 mm.
55. A coated article according to any of the preceding embodiments directed to coated articles comprising an article, a primer coated on the article, and a layer coated on the coated primer, wherein the layer coated on the primer comprises the dried component A according to any of the preceding embodiments directed to a kit, wherein the dried component A layer is sag resistant to a thickness of up to 3 mm under the Sag Resistant Test.
56. A coated article according to any of the preceding embodiments directed to a coated article comprising the dried composition from component A according to any of the embodiments directed to a kit, wherein the dried component A layer is sag resistant to a thickness of up to 2.5 mm under the Sag Resistant Test.
57. A coated article according to any of the preceding embodiments directed to a coated article comprising the dried composition from component A according to any of the embodiments directed to a kit, wherein the dried component A layer is sag resistant to a thickness of up to 2 mm under the Sag Resistant Test.
58. A coated article according to any of the preceding embodiments directed to a coated article comprising the dried composition from component A according to any of the embodiments directed to a kit, wherein the dried component A layer is sag resistant to a thickness in the range from 0.4 mm to 3 mm under the Sag Resistant Test.
59. A coated article according to any of the preceding embodiments directed to a coated article comprising the dried composition from component A according to any of the embodiments directed to a kit, wherein the dried component A layer is sag resistant to a thickness in the range from 1 mm to 2 mm under the Sag Resistant Test.
60. A coated article according to any of the preceding embodiments directed to a coated article comprising the dried composition from component A according to any of the embodiments directed to a kit, wherein the intumesced (expanded) layer comprising the dried coating has a thickness at least 80% higher than the non-intumesced thickness when the remaining water in the intumesced layer is 10%.
61. A coated article according to any of the preceding embodiments directed to a coated article comprising the dried composition from component A according to any of the embodiments directed to a kit, wherein the intumesced layer comprising the dried coating has a thickness at least 100% higher than the non-intumesced thickness when the remaining water in the intumesced layer is 10%.
62. A coated article according to any of the preceding embodiments directed to a coated article comprising the dried composition from component A according to any of the embodiments directed to a kit, wherein the intumesced layer comprising the dried coating has a thickness at least 150% higher than the non-intumesced thickness when the remaining water in the intumesced layer is 10%.
63. A coated article according to any of the preceding embodiments directed to a coated article comprising the dried composition from component A according to any of the embodiments directed to a kit, wherein the intumesced layer comprising the dried coating has a thickness at least 180% higher than the non-intumesced thickness when the remaining water in the intumesced layer is 10%.
64. A coated article according to any of the preceding embodiments directed to a coated article comprising the dried composition from component A according to any of the embodiments directed to a kit, wherein the intumesced layer comprising the dried coating has a dielectric strength at least 2000% higher than the non-intumesced dielectric strength when measured according to the section “Measurement of Dielectric Strength”.
65. A method of applying an intumescent coating to a substrate comprising:
   applying a primer (component A) to a substrate, wherein the primer is in a solution or emulsion,
   drying the primer solution or emulsion to create a primer surface;
   applying a liquid composition (component B) to the primer surface,
   wherein the primer is an acrylic polymer,
   wherein the liquid composition comprises:
      an inorganic binder chosen from potassium silicate, sodium silicate, or a combination thereof, and
      at least one inorganic filler;
      wherein the composition has a shear thinning viscosity at a shear rate of 1·s⁻¹ of at least 275 Pa·s;
      wherein the composition has a shear thinning viscosity at a shear rate of 100·s⁻¹ of less than 10 Pa·s;
      wherein the composition has a moisture content of 35 wt % to 55 wt % with respect to the total weight of the composition;
      wherein the liquid composition is capable of being dried to a moisture content from 10 wt % to 25 wt % with respect to the total weight of the composition,
      wherein the dried composition, when it has a moisture content of 15 wt %±5 wt %, intumesces at a temperature of 100° C. or higher.
66. A method according to any of the preceding embodiments directed to a method, wherein component B is either a solution or an emulsion.
67. A method according to any of the preceding embodiments directed to a method, wherein component B is an aqueous emulsion comprising the acrylic polymer.
68. A method according to any of the preceding embodiments directed to a method, wherein component B comprises an acrylate copolymer.
69. A method according to any of the preceding embodiments directed to a method, wherein component B is an aqueous emulsion comprising an acrylate copolymer.
70. A method according to any of the preceding embodiments directed to a method, wherein component B is an aqueous emulsion comprising an acrylate styrene copolymer.
71. A method according to any of the preceding embodiments directed to a method, wherein component B is a non-aqueous solution comprising an acrylic polymer.
72. A method according to any of the preceding embodiments directed to a method, wherein component B is a non-aqueous solution comprising an acrylic copolymer.
73. A method according to any of the preceding embodiments directed to a method, wherein component B is a non-aqueous solution comprising an acrylic styrene copolymer.

### EXAMPLES

These examples are for illustrative purposes only and are not meant to be limiting on the scope of the appended claims. Unless otherwise noted or readily apparent from the context, all parts, percentages, ratios, etc. in the Examples and the rest of the specification are by weight. Where applicable, brand names and trademarked names are shown in all caps.

TABLE 1
Materials

| Designation | Description | Function | Source |
|---|---|---|---|
| Silicate | Sodium Silicate Type N | Binder | PQ Corp, Malvern, PA, United |
| | 37.5% solution | | States |
| Clay | Kaolin Clay POLYPLATE | Filler | KaMin, Macon, GA, United States |
| | P | | |
| Glycerin | Glycerin | Humectant | VWR Chemicals BDH, Radnor, |
| | | | PA, United States |
| E-coat steel | Epoxy-coated steel panel | Substrate | E-coat steel, Catalog Number |
| | coated by an | | ACT CRS 12X12X030 C700 C59 |
| | electrochemical process | | IMMERSION DIW; UNPOLISH |
| | | | ECOAT: ED6100C, obtained from |
| | | | ACT Test Panels, Hillsdale, MI. |
| Epoxy panel | Fiber-reinforced epoxy | Substrate | Multipurpose Flame-Retardant |
| | sheet | | Garolite G-10/FR4 Sheet, Catalog |
| | | | number 85345K713, obtained |
| | | | from McMaster-Carr, |
| | | | Douglasville, GA. |
| 3M 4298 UV | Acrylic-containing primer | Primer | 3M Adhesion Promoter 4298UV, |
| | solution | | commercial product by 3M |
| | | | Company |
| Water-based | Acrylic primer | Primer | Lanco Acrylic Primer Sealer AS- |
| acrylic | | | 210, by Lanco, SAN LORENZO, |
| | | | PUERTO RICO, 00754 |
| Water-based | Styrene Acrylic Emulsion | Primer | AMES “Super Primer”, by Ames |
| styrene-acrylic | | | Research Laboratories, Inc. Salem, |
| copolymer | | | Oregon 97302 |
| Water-based | Acrylic emulsion with | Primer | INSL-X Prime All AP-1000, by |
| acrylic with | pigment | | Benjamin Moore & Co., |
| pigment | | | Montvale, NJ 07645 |
| Water-based | Styrene Acrylic emulsion | Primer | ZINSSER Bulls-Eyes 1-2-3 water- |
| styrene-acrylic | with pigment | | based primer, by Rust-Oleum |
| with pigment | | | Corp., Vernon Hill, Illinoi 60061 |
| 3M Adhesive | Metal alkoxide primer | Primer | 3M Adhesion Promoter 111, Metal |
| Promoter 111 | | | alkoxide, commercial product by |
| | | | 3M Company |
| Amino Silane | Amino silane Primer | Primer | (3-Aminopropyl)triethoxysilane, |
| | | | obtained from Sigma Aldrich |
| | | | Chemical Company; Milwaukee, |
| | | | WI |
| Posi-Test Kit | Coating Adhesion strength | Test kit | PosiTest AT-A, Automatic |
| AT-A | test kit | | Pull = Off Adhesion Tester, by |
| | | | DeFelsko, Ogdensburg, New York |
| | | | 13669-2205 |

### Test Methods

### Dynamic Shear Viscosity Test

Dynamic shear viscosity was measured using a TA Discovery Hybrid Rheometer HR-2 (TA Instruments).

DIN concentric cylinders, Peltier Stainless steel 105958 had the following parameters:
Material Stainless steel
Bob diameter: 28.03 mm
Bob length: 42.12 mm
Cup diameter: 30.37 mm
Operating gap: 5923.33 um
Sample volume: 25 ml
Environmental system: Peltier
Test Temperature: 25° C.
Sample Conditioning step @ 25° C.:

Samples were loaded in the cup using a 30 ml syringe. Drew up ~1-2 mL into the syringe and dispensed it back into the sample container to prime the syringe once. The syringe was lowered into the sample and drawn up an ~25 mL sample and dispensed into the bottom of the cup. The DIN Bob was lowered to the operating gap and the solvent trap cover was installed. Samples were run with a preshear set at 10 l/s for 60 seconds, then equilibrated for 10 min. The following parameters were used in the rheometer's software (version 9.5):
Flow Sweep step at 25 C:
From 1 to 100 l/s at 5 points per decade.
Steady state sensing was enabled, max equilibration time was set to 60 seconds, sample period was set to 30 seconds, until 3 consecutive values were within a 10% tolerance.

### Sag Resistant Test

Samples were knife coated onto 10.16 cm×30.48 cm (4 inch×12 inch) aluminum plates at a wet thickness of 3.15 mm (0.124 inch). After coating, the plates were positioned upright (placed vertically at about a 90 degree angle±2 degrees on the 10.16 cm side) and left to dry 16 hr at 21° C. Dry thickness at top and bottom of plate were measured. If the two dry thicknesses were comparable (within 10% of each other), then the sample was determined to be sag resistant.

### Torch and Grit Test

A hydrogen/oxygen torch, a customized hydrogen/oxygen burner obtained from Bethlehem Apparatus, Hellertown, PA having a central channel for particulates and a ring of outer ports for fuel and oxidizer feeds, was first equilibrated to a designed flame temperature of 1200° C. or 1350° C. as measured by a thermocouple inserted into the flame cone one inch (2.54 cm) from the face of the torch. A sample panel prepared as described below in the Examples and the Comparative Examples was inserted into the flame at a distance of 2.38 inches (6.03 cm) from the torch face and simultaneously subjected to a series of blasts from a stream of 120 grit aluminum oxide abrasive media powered by a 25 psi (172.37 KPa) compressed air source aligned along the same axis as the torch. An individual grit cycle consisted of 10 seconds of grit exposure followed by a 5 second break; the hot flame was maintained throughout. This blast/rest cycle was continued until the coating penetration was observed. In all cases the coated sample side was oriented towards the flame and the number of cycles to coating failure was recorded. Coating does turn brown as the glycerol oxidizes but does not ignite (no flame) and no smoke is observed. Intumescence is observed.

### Measurement of Dielectric Strength

The dielectric strength of each specimen was measured using a ViTREK 957i Electrical Safety Compliance Analyzer, following ASTM3755-R100 measuring the total breakdown voltage for the specimen tested. The dielectric strength represents the voltage through the specimen (both the 1.25 mm aluminum plate and the dried coating) with a 0.4 mA current limit. The dielectric breakdown voltage represents the voltage thru the specimen at a given thickness rather than voltage per mm.

### Adhesion Test

A primer solution was coated onto a panel (e.g., E-coat steel or epoxy panel) with a sponge applicator. The coating was allowed to dry at room temperature (23° C.) for 1 hour. The base of the aluminum dolly (20 mm diameter dolly from Posi-Test Kit AT-A) was coated entirely with the test ceramic coating solution (e.g., Component A from the kit) and pressed gently onto the primer-coated panel and dried for 3 days at 50° C. Adhesion strength was measured following the instructions in the PosiTest kit. Results of the adhesion strength of the ceramic coating on the panel with various primers are tabulated in Table 9.

### Examples 1-8 (EX1-EX8) and Comparative Examples 1-2 (CE1-CE2)

Batches of the liquid composition were created by mixing quantities (defined in kilograms (kg)) of materials identified in Table 2 in a 5-gallon Dual Shaft mixer from ROSS of Hauppauge, NY, United States. Samples created from the batches as identified in Table 3 (defined in weight percent (wt. %)) were then mixed and underwent Dynamic Shear Viscosity and Sag Resistant testing. Results of the tests are represented in Table 4.

TABLE 2
Liquid Composition Batches

| | Silicate | Clay | Glycerin |
|---|---|---|---|
| | kg | kg | kg |
| Batch | (lbs) | (lbs) | (lbs) |
| B1 | 12.02 | 3.76 | 0.16 |
| | (26.50) | (8.3) | (0.35) |
| B2 | 11.62 | 4.16 | 0.16 |
| | (25.62) | (9.18) | (0.35) |
| B3 | 11.22 | 4.56 | 0.16 |
| | (24.74) | (10.06) | (0.35) |
| B4 | 10.82 | 4.96 | 0.16 |
| | (23.86) | (10.94) | (0.35) |
| B5 | 10.82 | 4.96 | 0.16 |
| | (23.86) | (10.94) | (0.35) |
| B6 | 10.82 | 4.96 | 0.16 |
| | (23.86) | (10.94) | (0.35) |
| B7 | 10.42 | 5.36 | 0.16 |
| | (22.98) | (11.82) | (0.35) |
| B8 | 10.42 | 5.36 | 0.16 |
| | (22.98) | (11.82) | (0.35) |
| B9 | 10.02 | 5.76 | 0.16 |
| | (22.10) | (12.70) | (0.35) |
| B10 | 9.63 | 6.16 | 0.16 |
| | (21.22) | (13.58) | (0.35) |

TABLE 3
Liquid Composition Samples

| | | Silicate | Clay | Glycerin | % Solids^{(a)} |
|---|---|---|---|---|---|
| | Batch | (wt. %) | (wt. %) | (wt. %) | (%) |
| CE1 | B1 | 75.39 | 23.61 | 1.00 | 51.9 |
| CE2 | B2 | 72.89 | 26.11 | 1.00 | 53.4 |
| EX1 | B3 | 70.38 | 28.62 | 1.00 | 55.0 |
| EX2 | B4 | 67.88 | 31.12 | 1.00 | 56.6 |
| EX3 | B5 | 67.88 | 31.12 | 1.00 | 56.6 |
| EX4 | B6 | 67.88 | 31.12 | 1.00 | 56.6 |
| EX5 | B7 | 65.38 | 33.62 | 1.00 | 58.1 |
| EX6 | B8 | 62.87 | 36.13 | 1.00 | 59.7 |
| EX7 | B9 | 60.37 | 38.63 | 1.00 | 61.3 |
| EX8 | B10 | 65.38 | 33.62 | 1.00 | 58.1 |

^{(a)}= % solids tested at 500° C. for 20 minutes

TABLE 4
Liquid Composition Viscosity and Sag Resistant Test Results

| | | | Viscosity | Viscosity | Viscosity |
|---|---|---|---|---|---|
| | | Sag | @ 1 1/s | @ 10 1/s | @ 100 1/s |
| | Batch | Resistant | (Pa · s) | (Pa · s) | (Pa · s) |
| CE1 | B1 | No | 155.56 | 11.09 | 1.87 |
| CE2 | B2 | No | 247.63 | 19.00 | 2.94 |
| EX1 | B3 | yes | 306.93 | 22.04 | 2.51 |
| EX2 | B4 | yes | 541.74 | 42.58 | 5.64 |
| EX3 | B5 | yes | 620.50 | 50.03 | 6.25 |
| EX4 | B6 | yes | 613.51 | 48.37 | 6.01 |
| EX5 | B7 | yes | 683.11 | 52.89 | 6.69 |
| EX6 | B8 | yes | 908.76 | 86.02 | 9.19 |
| EX8 | B10 | yes | 914.32 | 79.61 | 9.43 |

Samples underwent Torch and Grit testing, and the results are represented in Table 5.

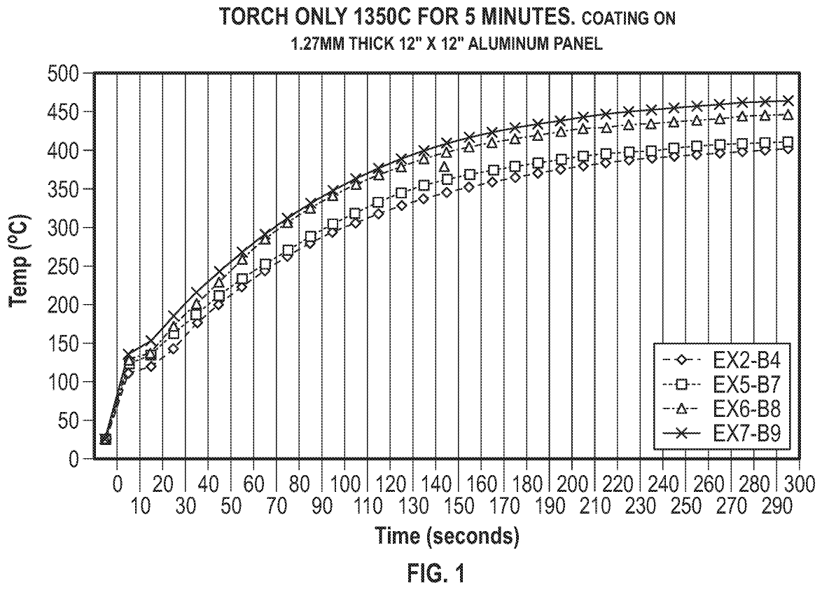

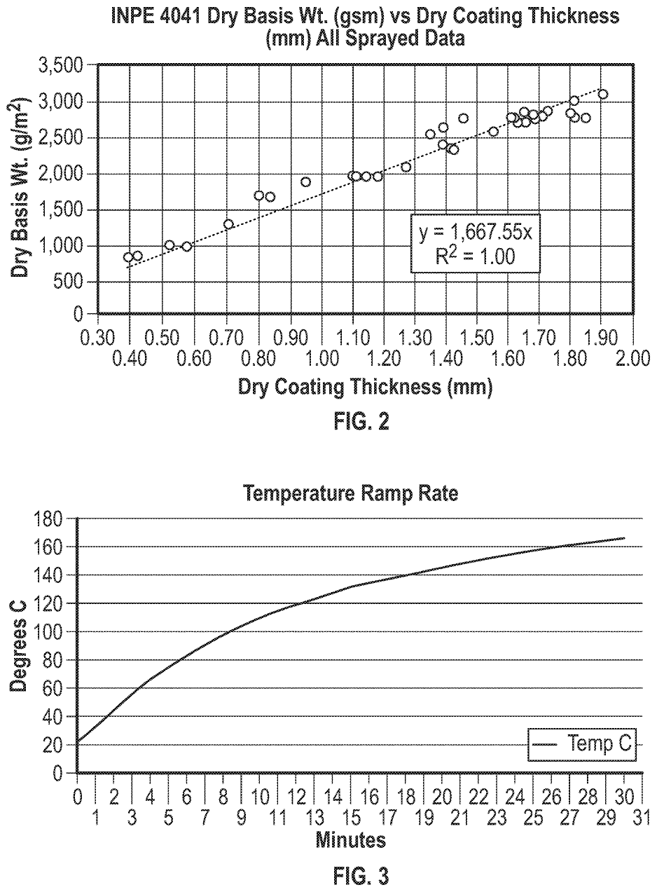

TABLE 5
Data represented in FIG. 1

| Time (Sec) | EX 2 | EX 5 | EX 6 | EX 7 |
|---|---|---|---|---|
| 0 | 25 | 25 | 25 | 25 |
| 10 | 111 | 123 | 129 | 136 |
| 20 | 119 | 135 | 137 | 153 |
| 30 | 142 | 162 | 173 | 185 |
| 40 | 176 | 188 | 201 | 216 |
| 50 | 200 | 212 | 229 | 243 |
| 60 | 222 | 234 | 259 | 268 |
| 70 | 244 | 253 | 286 | 292 |
| 80 | 262 | 270 | 307 | 313 |
| 90 | 281 | 289 | 326 | 333 |
| 100 | 293 | 305 | 341 | 349 |
| 110 | 307 | 319 | 357 | 364 |
| 120 | 317 | 333 | 369 | 377 |
| 130 | 329 | 346 | 379 | 390 |
| 140 | 337 | 355 | 390 | 400 |
| 150 | 345 | 361 | 399 | 410 |
| 160 | 353 | 369 | 405 | 418 |
| 170 | 360 | 374 | 411 | 425 |
| 180 | 366 | 379 | 415 | 430 |
| 190 | 370 | 384 | 420 | 435 |
| 200 | 376 | 389 | 425 | 439 |
| 210 | 380 | 392 | 429 | 444 |
| 220 | 384 | 396 | 430 | 448 |
| 230 | 388 | 399 | 434 | 451 |
| 240 | 391 | 400 | 435 | 453 |
| 250 | 392 | 403 | 438 | 455 |
| 260 | 396 | 406 | 439 | 458 |
| 270 | 397 | 408 | 442 | 460 |
| 280 | 399 | 409 | 445 | 463 |
| 290 | 400 | 410 | 446 | 464 |
| 300 | 403 | 412 | 448 | 465 |

### Examples 9-16 (EX9-EX16) and Comparative Examples 3-6 (CE3-CE6)

### Example 9 (EX9)

A ceramic coating solution was made by mixing kaolin powder, sodium silicate solution (37.5% solid in water) and glycerol with 31.126% kaolin, 67.878% sodium silicate solution and 0.996% glycerol in a Ross mixer. Acrylic polymer-containing 3M 4298UV adhesion promoter was coated onto an E-coat steel panel with a sponge applicator. The acrylic-containing coating was dried at room air for 1 hour. Small amount of ceramic coating solution was applied to an aluminum dolly and pressed gently onto the acrylic polymer-coated E-coat steel panel and dried for 3 days at 50° C.

An Adhesion Test was conducted using Posi-Test kit to measure the adhesion strength which showed 0.62 MPa before the detachment occurred as shown in Table 9.

### Example 10 (EX10)

Similar to Example 9, but water-based acrylic primer was used. Adhesion strength was measured and tabulated in Table 9.

### Example 11 (EX11)

Similar to Example 9, but water-based styrene-acrylic copolymer primer was used. Adhesion strength was measured and tabulated in Table 9.

### Example 12 (EX12)

Similar to Example 9, but water-based acrylic polymer with pigment primer was used. Adhesion strength was measured and tabulated in Table 9.

### Example 13 (EX13)

Similar to Example 9, but water-based styrene-acrylic copolymer with pigment primer was used. Adhesion strength was measured and tabulated in Table 9.

### Example 14 (EX14)

Similar to Example 11, but epoxy panel was used as substrate. Adhesion strength was measured and tabulated in Table 9.

### Example 15 (EX15)

Similar to Example 12, but epoxy panel was used as substrate. Adhesion strength was measured and tabulated in Table 9.

### Example 16 (EX16)

Similar to Example 13, but epoxy panel was used as substrate. Adhesion strength was measured and tabulated in Table 9.

### Example CE3 (Comparative Example)

Similar to Example 9, but Metal alkoxide primer 3M Adhesive Promoter 111 was used. Adhesion strength was measured to be 0.30 MPa and tabulated in Table 9.

### Example CE4 (Comparative Example)

Similar to Example 9, but solution of 20% Amino silane in Isopropanol as primer was used. Adhesion strength was measured to be 0.38 MPa and tabulated in Table 9.

Example CE5 (Comparative example) Similar to Example 9, but with bare E-coat steel panel. Adhesion strength was measured to be 0.10 MPa which is the minimum reading of the instrument and tabulated in Table 9.

Example CE6 (Comparative example) Similar to Example 9, but with bare Epoxy panel. Adhesion strength was measured to be 0.10 MPa which is the minimum reading of the instrument and tabulated in Table 9.

### Shelf Life

This test provides the results of a sample of Batch 7 that was stored at room temperature (21° C.) in a vertical condition in a polyethylene container for the time described below. No gelation or precipitation was observed. To check for filler settling (homogeneity), a plastic syringe was used to extract material from the top of the container (“Top Sample.”) This material was tested for % solids. The test involved placing about 10 grams in an aluminum tray and placing it in a 500° C. furnace for 20 minutes. The percent solids was calculated based on the starting mass and the ending mass. For the Bottom Sample, a hole was cut in the bottom of the container, a plastic syringe was used to extract a sample and the process was repeated. After the test, the sample and the polyethylene container were discarded. A viable shelf life is defined as the slurry having a difference of less than 3% in solids between the Top Sample and the Bottom Sample. This process was repeated periodically with an unopened polyethylene container to test for the shelf life of the material at various points in time.
Material B7 above;
Date produced: Apr. 5, 2022; Date tested: Feb. 7, 2023
Material state: Viscous slurry. No gelation or settling
% solids at top of container: 56% (500 C 20 minutes)
% solids at bottom of container: 56.3% (500 C 20 minutes)
Material B7 above;
Date produced: Apr. 5, 2022; Date tested: Jun. 29, 2023
Material state: Viscous slurry. No gelation or settling
% solids at top of container: 55.95% (500 C 20 minutes)
% solids at bottom of container: 55.97% (500 C 20 minutes)
Material B7 above;
Date produced: Apr. 5, 2022; Date tested: Jan. 23, 2024
Material state: Viscous slurry. No gelation or settling
% solids at top of container: 55.22% (500 C 20 minutes)
% solids at bottom of container: 55.7% (500 C 20 minutes

### % Expansion Vs % Retained Water Vs Dielectric Resistance

Batch 6 slurry coated on 0.05″ aluminum panel and dried to various amounts of retained water. We observed intumescence in the samples when the temperature was about 95° C. to 105° C. (hot plate temperature).

Heated on hot plate with coating side facing upwards. Ramped from 72 F to 328 F (0.5 hours) Some large bubbles emerge during heating process. These bubbles were excluded from expanded measurement. Three thickness measurements were taken per specimen and averaged.

TABLE 6

| | | | | | | Dielectric | |
|---|---|---|---|---|---|---|---|
| | | | | | | breakdown | |
| | initial | | | | | voltage | Remaining |
| | thickness | Expanded | | | Average | before | water in |
| | of coating | thickness | Expansion | % | expansion | expansion | coating |
| Sample | (in) | (in) | (in) | expansion | (%) | (V) | (wt %) |
| 1 | 0.08033 | 0.282 | 0.201667 | 251% | | | |
| | 0.08033 | 0.242 | 0.161667 | 201% | | | |
| | 0.08033 | 0.245 | 0.164667 | 205% | 219% | 170 | 21.8% |
| 2 | 0.069 | 0.215 | 0.146 | 212% | | | |
| | 0.069 | 0.185 | 0.116 | 168% | | | |
| | 0.069 | 0.229 | 0.16 | 232% | 204% | 344 | 18.5% |
| 3 | 0.06433 | 0.185 | 0.120667 | 188% | | | |
| | 0.06433 | 0.204 | 0.139667 | 217% | | | |
| | 0.06433 | 0.191 | 0.126667 | 197% | 201% | 624 | 16.1% |
| 4 | 0.07267 | 0.23 | 0.157333 | 217% | | | |
| | 0.07267 | 0.182 | 0.109333 | 150% | | | |
| | 0.07267 | 0.205 | 0.132333 | 182% | 183% | 1577 | 13.8% |
| 5 | 0.056 | 0.172 | 0.116 | 207% | | | |
| | 0.056 | 0.158 | 0.102 | 182% | | | |
| | 0.056 | 0.171 | 0.115 | 205% | 198% | 6506 | 10.9% |
| 6 | 0.06767 | 0.115 | 0.047333 | 70% | | | |
| | 0.06767 | 0.141 | 0.073333 | 108% | | | |
| | 0.06767 | 0.119 | 0.051333 | 76% | 85% | 12000 | 9.7% |
| 7 | 0.053 | 0.098 | 0.045 | 85% | | | |
| | 0.053 | 0.058 | 0.005 | 9% | | | |
| | 0.053 | 0.069 | 0.016 | 30% | 42% | 12000 | 6.6% |

TABLE 7
Hot plate temperature curve

| Time min | Temp F. | temp ° C. |
|---|---|---|
| 0 | 72 | 22 |
| 1 | 90 | 32 |
| 2 | 113 | 45 |
| 3 | 132 | 56 |
| 4 | 150 | 66 |
| 5 | 166 | 74 |
| 6 | 181 | 83 |
| 7 | 195 | 91 |
| 8 | 207 | 97 |
| 9 | 217 | 103 |
| 10 | 228 | 109 |
| 11 | 237 | 114 |
| 12 | 244 | 118 |
| 13 | 252 | 122 |
| 14 | 258 | 126 |
| 15 | 267 | 131 |
| 16 | 272 | 133 |
| 17 | 276 | 136 |
| 18 | 282 | 139 |
| 19 | 286 | 141 |
| 20 | 292 | 144 |
| 21 | 296 | 147 |
| 22 | 301 | 149 |
| 23 | 305 | 152 |
| 24 | 309 | 154 |
| 25 | 313 | 156 |
| 26 | 316 | 158 |
| 27 | 319 | 159 |
| 28 | 322 | 161 |
| 29 | 325 | 163 |
| 30 | 328 | 164 |

### Dielectric Breakdown Changes Between Unexpanded and Expanded Dried Coating

Slurry from Example 4 subjected to dielectric testing. After coating and drying, a sample measuring 4″×12″ was cut into individual 2″×4″ specimens. Three samples were tested for dielectric breakdown. The samples were then heated at 225° C. for 10 min to induce intumescence then re-tested for dielectric breakdown. Values measured are shown in the table below.

TABLE 8
Results from dielectric testing s

| | Non expanded | Expanded | | | non expanded | | expanded | |
|---|---|---|---|---|---|---|---|---|
| | thickness | Thickness | | % | Dielectric | | Dielectric | |
| sample | 1 mm | 2 mm | Change | change | V 1 (V) | Amps | V 2 (V) | Amps |
| 1 | 1.4732 | 5.715 | 0.167 | 388% | 468 | 409 uA | 12K | 33 uA |
| 2 | 1.5494 | 5.08 | 0.139 | 328% | 451 | 400 uA | 11.5K | 25 uA |
| 3 | 2.2352 | 7.4168 | 0.204 | 332% | 368 | 407 uA | 12K | 14 uA |

### Torch and Grit Example:

| Coating solution | Dry thickness mm | Torch and grit result |
|---|---|---|
| Ex 4 | 1.19 | Pass |
| Ex 4 | 1.42 | Pass |

Pass = no penetration of coating after 12 grit blasts.

Coated on 0.6 mm stainless steel substrate.

All coated articles are kept under conditions that prevent the retained water in the coating from boiling. If the water in the slurry begins to boil the steam produced causes premature intumescence of the coating resulting in the coating swelling. This premature expansion may prevent the coating from intumescing properly when an actual battery fire occurs (e.g., when the temperature of the coating reaches about 100° C. To achieve a compatible coating thickness, drying between 20° C. and 90° C. is desired.

To show the impact of excessive heat while drying, this example shows how the material reacts to excessive heat. Below the coated sample (on 0.05″ aluminum) was allowed to dry 16 h at ambient conditions at 20° C. then it was heated at 80 C for 40 minutes and finally heated at 120° C. for 60 minutes. Typically, under more gentile drying conditions as mentioned in the paragraph above the material would exhibit no expansion when compared to the thickness before thermal exposure (drying). The thickness reported below are for the coating only; the aluminum panel thickness was subtracted.

| | | | | | | | | Thick- | Thick- | |
|---|---|---|---|---|---|---|---|---|---|---|
| | Plate | total | Wet | Dry | | | | ness | ness | |
| | weight | weight | coating | coating | Theoretical | Water | wt. % | before | after | % |
| | (g) | (g) | (g) | (g) | Solids (g) | (g) | water | mm | mm | Expansion |
| Dry profile | 153.4 | 327 | 173.6 | 153.6 | 99.95 | 53.65 | 34.9% | 3.00 | 2.794 | −7% |
| Over night | 76.7 | 163.5 | 86.8 | 75.81 | 49.97 | 25.84 | 34.1% | 2.79 | 2.06 | −26% |
| 80 C. for 40 | | | | | | | | | | |
| min | | | | | | | | | | |
| 120 C. for | 76.7 | 163.5 | 86.8 | 60.22 | 49.97 | 10.25 | 17.0% | 2.06 | 19.05 | 826% |
| 60 min | | | | | | | | | | |

TABLE 9
Adhesion Strength Data

| Exam- | | | Adhesion |
|---|---|---|---|
| ple | | | Strength, |
| No | Substrate | Primer | MPa |
| EX9 | E-coat steel | Acrylic and rubber in organic solvent | 0.62 |
| | | (3M 4298UV Adhesion Promoter) | |
| EX10 | E-coat steel | Acrylic in water | 0.54 |
| EX11 | E-coat steel | Styrene-acrylic in water | 0.64 |
| EX12 | E-coat steel | Acrylic with pigment in water | 0.68 |
| EX13 | E-coat steel | Styrene-acrylic with pigment in water | 0.66 |
| EX14 | Epoxy panel | Styrene-acrylic in water | 0.65 |
| EX15 | Epoxy panel | Acrylic with pigment in water | 0.60 |
| EX16 | Epoxy panel | Styrene-acrylic with pigment in water | 0.56 |
| CE3 | E-coat steel | 3M Adhesion Promoter 111 (Metal | 0.30 |
| | | alkoxide) | |
| CE4 | E-coat steel | Amino silane | 0.38 |
| CE5 | E-coat steel | None | 0.10 |
| CE6 | Epoxy panel | None | 0.10 |

1. A kit comprising at least two components:
a component A comprising a liquid composition comprising:
an inorganic binder chosen from potassium silicate, sodium silicate, or a combination thereof, and
at least one inorganic filler;
wherein the composition has a shear thinning viscosity at a shear rate of 1·s⁻¹ of at least 275 Pa·s;
wherein the composition has a shear thinning viscosity at a shear rate of 100·s⁻¹ of less than 10 Pa·s;
wherein the composition has a moisture content of 35 wt % to 55 wt % with respect to the total weight of the composition;
wherein the liquid composition is capable of being dried to a moisture content from 10 wt % to 25 wt % with respect to the total weight of the composition,
wherein the dried composition, when it has a moisture content of 15 wt %±5 wt %, intumesces at a temperature of 100° C. or higher; and
a component B comprising an acrylic polymer.

2. A kit according to claim 1, wherein component B is an aqueous emulsion comprising the acrylic polymer.

3. A kit according to claim 1, wherein component B is an aqueous emulsion comprising an acrylate styrene copolymer.

4. A kit according to claim 1, wherein component B is a non-aqueous solution comprising an acrylic polymer.

5. A kit according to claim 1, wherein the liquid composition of component A has a shear thinning viscosity at a shear rate of 1·s⁻¹ of 300 Pa·s to 1000 Pa·s.

6. A kit according to claim 1, wherein the liquid composition of component A has a shear thinning viscosity at a shear rate of 100·s⁻¹ of less from 1 Pa·s to 10 Pa·s.

7. A kit according to claim 1, wherein the liquid composition of component A has a moisture content of 35 wt % to 45 wt % with respect to the total weight of the composition.

8. A kit according to claim 1, wherein the inorganic filler is chosen from: clay, ceramic fibers, vermiculite, hollow ceramic microspheres, perlite, zeolite, mica, hexagonal boron nitride, silicon nitride, and combinations thereof.

9. A kit according to claim 1, wherein the liquid composition has a shelf life of 6 months or greater.

10. A coated article comprising an article, a primer coated on the article, and a layer coated on the coated primer, wherein the layer coated on the primer comprises the dried component A according to claim 1 directed to a kit.

11. A coated article according to claim 10 directed to coated articles comprising an article, a primer coated on the article, and a layer coated on the coated primer, wherein the layer coated on the primer comprises the dried component A according to any of the preceding claims directed to a kit, wherein the dried component A has a moisture content from 10 wt % to 25 wt %.

12. A coated article according to claim 10 directed to coated articles comprising an article, a primer coated on the article, and a layer coated on the coated primer, wherein the layer coated on the primer comprises the dried component A according to any of the preceding claims directed to a kit, wherein the article is made of a coated metal, wherein the primer coated on the article is in contact with the dried component A composition, and wherein the primer is chosen from amino silane, metal alkoxide and acrylate, and commercial primers 3M Adhesion Promoter 111 and 3M Adhesion Promoter 4298UV.

13. A coated article according to claim 10 directed to coated articles comprising an article, a primer coated on the article, and a layer coated on the coated primer, wherein the layer coated on the primer comprises the dried component A according to any of the preceding claims directed to a kit, wherein the dried component A layer is sag resistant to a thickness in the range from 0.4 mm to 3 mm under the Sag Resistant Test.

14. A coated article according to claim 10 directed to coated articles comprising an article, a primer coated on the article, and a layer coated on the coated primer, wherein the layer coated on the primer comprises the dried component A according to any of the preceding claims directed to a kit, wherein the adhesion strength between the layer comprising the dried component A and the panel is greater than 0.4 MPa in the Adhesion Test.

15. A coated article according to claim 10 directed to a coated article comprising the dried composition from component A according to any of the embodiments directed to a kit, wherein the article is made of a coated metal and comprises a primer on the surface that is in contact with the dried composition; wherein the coated metal is chosen from e-coat aluminum and e-coat steel.

16. A method of applying an intumescent coating to a substrate comprising:
applying a primer (component A) to a substrate, wherein the primer is in a solution or emulsion,
drying the primer solution or emulsion to create a primer surface;
applying a liquid composition (component B) to the primer surface,
wherein the primer is an acrylic polymer,
wherein the liquid composition comprises:
an inorganic binder chosen from potassium silicate, sodium silicate, or a combination thereof, and
at least one inorganic filler;
wherein the composition has a shear thinning viscosity at a shear rate of 1·s⁻¹ of at least 275 Pa·s;
wherein the composition has a shear thinning viscosity at a shear rate of 100·s⁻¹ of less than 10 Pa·s;
wherein the composition has a moisture content of 35 wt % to 55 wt % with respect to the total weight of the composition;
wherein the liquid composition is capable of being dried to a moisture content from 10 wt % to 25 wt % with respect to the total weight of the composition,
wherein the dried composition, when it has a moisture content of 15 wt %±5 wt %, intumesces at a temperature of 100° C. or higher.
